(19) United States
(12) Patent Application Publication
(10) Pub. No.: US 2007/0231615 A1
(43) Pub. Date: Oct. 4, 2007

(54) Magnetic recording medium

(75) Inventors: Shinji Tsujimoto, Odawara-shi (JP); Takeshi Harasawa, Odawara-shi (JP)

Correspondence Address: SUGHRUE-265550, 2100 PENNSYLVANIA AVE. NW, WASHINGTON, DC, 20037-3213, US

(73) Assignee: FUJIFILM Corporation, Minato-ku (JP)

(21) Appl. No.: 11/730,436

(22) Filed: Apr. 2, 2007

(30) Foreign Application Priority Data
Mar. 31, 2006 (JP) P 2006-099941

(51) Int. Cl. G11B 5/708

(52) U.S. Cl. 428/842.8; 428/845

(57) ABSTRACT

A magnetic recording medium including: a back coat layer; a nonmagnetic support; and coated layers including: a nonmagnetic layer containing nonmagnetic powder and a binder; and a magnetic layer containing ferromagnetic powder and a binder, so that the back coat layer, the nonmagnetic support, the nonmagnetic layer and the magnetic layer are provided in this order, wherein the ferromagnetic powder is ferromagnetic hexagonal ferrite powder having an average tabular size of less than 30 nm, and a central plane surface roughness Ra of the magnetic layer, a central plane surface roughness Ra of the back coat layer, a glass transition point of the coated layers, a glass transition point of the back coat layer and a ratio of a Young's modulus of the magnetic layer to a Young's modulus of the back coat layer are defined herein.

### FIELD OF THE INVENTION

The present invention relates to a magnetic recording medium, more specifically relates to a magnetic recording medium capable of achieving smoothness of a magnetic layer suitable for high density recording and having high electromagnetic characteristics.

### BACKGROUND OF THE INVENTION

In recent years, means for transmission of the data of tera-byte class at high speed have conspicuously developed and transmission of vast amounts of data including images has become possible on one hand, so that high techniques for the recording, reproduction and storage of these data are required on the other hand. Flexible discs, magnetic drums, hard discs and magnetic tapes are exemplified as recording and reproducing media. In particular, magnetic tapes have high recording capacity per a roll, so that the role of magnetic tapes in recording and reproducing is great including a data backup use.

On the other hand, for increasing the recording capacity of a magnetic recording medium, higher recording density is necessary, and fining of magnetic particles in a magnetic layer and surface smoothing are discussed for that sake. Smoothing of magnetic layer surface is disclosed in JP-A-2005-18821 (The term “JP-A” as used herein refers to an “unexamined published Japanese patent application”.) (corresponding to US 2004/0265643 A1), JP-A-2005-4918, JP-A-2004-5827 (corresponding to US 2003/0224210 A1) and JP-A-2004-5793 (corresponding to US 2003/0228492 A1). Further, an anisotropic magneto-resistive reproducing head (a so-called AMR head) and a giant magneto-resistive reproducing head having higher sensitivity (a so-called GMR head) are also proposed.

However, still higher recording density is required nowadays, so that the smoothness of a magnetic layer that sufficiently satisfies the requirement cannot be obtained by the techniques disclosed in JP-A-2005-18821 (corresponding to US 2004/0265643 A1), JP-A-2005-4918, JP-A-2004-5827 (corresponding to US 2003/0224210 A1) and JP-A-2004-5793 (corresponding to US 2003/0228492 A1).

### SUMMARY OF THE INVENTION

Accordingly, an object of the invention is to provide a magnetic recording medium capable of achieving the smoothness of a magnetic layer that is sufficient to satisfy high density recording required at present and having high electromagnetic characteristics.

The present invention is as follows.

(1) A magnetic recording medium comprising a nonmagnetic support having a nonmagnetic layer containing nonmagnetic powder and a binder, and a magnetic layer containing ferromagnetic powder and a binder in this order on one side thereof, and a back coat layer on the other side thereof, wherein the ferromagnetic powder is ferromagnetic hexagonal ferrite powder having an average tabular size of less than 30 nm, the central plane surface roughness Ra of the magnetic layer is from 1.0 to 2.5 nm, the central plane surface roughness Ra of the back coat layer is from 2.0 to 4.0 nm, the glass transition point Tg of the coated layers including the magnetic layer and the nonmagnetic layer is from 75 to 100° C., the glass transition point Tg of the back coat layer is from 75 to 100° C., and the ratio of the Young's modulus of the magnetic layer (Ym) to the Young's modulus of the back coat layer (Yb), (R=Ym/Yb), is from 0.8 to 1.20. In this regard, the “coated layers” is defined to include all of layers provided on a side of the nonmagnetic support in which the magnetic layer and the nonmagnetic layer are provided (a side opposite to the side of the nonmagnetic support in which the back coat layer is provided).

According to the invention, by specifying the kind and size of the ferromagnetic powder, the central plane surface roughness Ra of the magnetic layer, the central plane surface roughness Ra of the back coat layer, the glass transition point Tg of the coated layers, the glass transition point Tg of the back coat layer, and the ratio of the Young's modulus of the magnetic layer (Ym) to the Young's modulus of the back coat layer (Yb), (R=Ym/Yb), the smoothness of a magnetic layer that is sufficient to satisfy high density recording required at present can be achieved, thus the invention can provide a magnetic recording medium having high electromagnetic characteristics.

### DETAILED DESCRIPTION OF THE INVENTION

The invention will be described in further detail below.

### Nonmagnetic Support:

As nonmagnetic supports for use in the invention, known films, such as polyesters, e.g., polyethylene terephthalate and polyethylene naphthalate, polyolefins, cellulose triacetate, polycarbonate, polyamide, polyimide, polyamideimide, polysulfone, polyaramid, aromatic polyamide and polybenzoxazole can be used. High strength supports such as polyethylene naphthalate and polyamide are preferably used. If necessary, a lamination type support as disclosed in JP-A-3-224127 can also be used to vary the surface roughness between a magnetic layer surface and a nonmagnetic support surface. These supports may be subjected to surface treatment in advance, e.g., corona discharge treatment, plasma treatment, adhesion assisting treatment, heat treatment or dust-removing treatment. Aluminum or glass substrate can also be used as the support in the invention.

Polyester supports (hereinafter merely referred to as “polyester”) are especially preferred. These polyesters are polyesters comprising dicarboxylic acid and diol, e.g., polyethylene terephthalate and polyethylene naphthalate.

As the dicarboxylic acid components of the main constitutional components, terephthalic acid, isophthalic acid, phthalic acid, 2,6-naphthalenedicarboxylic acid, 2,7-naphthalenedicarboxylic acid, diphenyl sulfone dicarboxylic acid, diphenyl ether dicarboxylic acid, diphenylethanedicarboxylic acid, cyclohexanedicarboxylic acid, diphenyldicarboxylic acid, diphenyl thioether dicarboxylic acid, diphenyl ketone dicarboxylic acid, and phenylindanedicarboxylic acid can be exemplified.

As the diol components, ethylene glycol, propylene glycol, tetramethylene glycol, cyclohexanedimethanol, 2,2-bis(4-hydroxyphenyl)propane, 2,2-bis(4-hydroxyethoxy-phenyl)propane, bis(4-hydroxyphenyl)sulfone, bisphenol fluorene dihydroxy ethyl ether, diethylene glycol, neopentyl glycol, hydroquinone, and cyclohexanediol can be exemplified.

Of polyesters comprising these dicarboxylic acids and diols as main constitutional components, from the points of transparency, mechanical strength and dimensional stability, polyesters mainly comprising terephthalic acid and/or 2,6-naphthalenedicarboxylic acid as the dicarboxylic acid components, and ethylene glycol and/or 1,4-cyclohexane-dimethanol as the diol components are preferred.

Of these polyesters, polyesters mainly comprising polyethylene terephthalate or polyethylene-2,6-naphthalate, copolymerized polyesters comprising terephthalic acid, 2,6-naphthalenedicarboxylic acid and ethylene glycol, and polyesters mainly comprising mixtures of two or more of these polyesters are preferred. Polyesters mainly comprising polyethylene-2,6-naphthalate are particularly preferred.

Polyesters for use in the invention may be biaxially stretched, or may be laminates of two or more layers.

Polyesters may further be copolymerized with other copolymerized components or mixed with other polyesters. As the examples thereof, the aforementioned dicarboxylic acid components, diol components, and polyesters comprising these components are exemplified.

With a view to hardly causing delamination when formed as a film, polyesters used in the invention may be copolymerized with aromatic dicarboxylic acids having a sulfonate group or ester formable derivatives thereof, dicarboxylic acids having a polyoxyalkylene group or ester formable derivatives thereof, or diols having a polyoxyalkylene group.

In view of polymerization reactivity of polyesters and transparency of films, sodium 5-sulfoisophthalate, sodium 2-sulfoterephthalate, sodium 4-sulfophthalate, sodium 4-sulfo-2,6-naphthalenedicarboxylate, compounds obtained by substituting the sodium of the above compounds with other metals (e.g., potassium, lithium, etc.), ammonium salt or phosphonium salt, or ester formable derivatives thereof, polyethylene glycol, polytetramethylene glycol, polyethylene glycol-polypropylene glycol copolymers, and compounds obtained by oxidizing both terminal hydroxyl groups of these compounds to make carboxyl groups are preferably used. The proportion to be copolymerized of these compounds for this purpose is preferably from 0.1 to 10 mol % on the basis of the amount of the dicarboxylic acids constituting the polyesters.

For improving heat resistance, bisphenol compounds, and compounds having a naphthalene ring or a cyclohexane ring can be copolymerized with polyesters. The proportion of the copolymerization of these compounds is preferably from 1 to 20 mol % on the basis of the amount of the dicarboxylic acids constituting the polyesters.

The synthesizing method of polyester is not especially restricted in the invention, and well-known manufacturing methods of polyesters can be used. For example, a direct esterification method of directly esterification reacting dicarboxylic acid component and diol component, and an ester exchange method of performing ester exchange reaction of dialkyl ester as the dicarboxylic acid component with diol component in the first place, which is then polymerized by heating under reduced pressure to remove the excessive diol component can be used. At this time, if necessary, an ester exchange catalyst, a polymerization reaction catalyst, or a heat resistive stabilizer can be added.

Further, one or two or more kinds of various additives, such as a coloring inhibitor, an antioxidant, a crystal nucleus agent, a sliding agent, a stabilizer, a blocking preventive, an ultraviolet absorber, a viscosity controller, a defoaming and clarifying agent, an antistatic agent, a pH adjustor, a dye, a pigment, and a reaction stopper may be added in each process of synthesis.

Fillers may be added to the polyesters. As the kinds of fillers, inorganic powders, e.g., spherical silica, colloidal silica, titanium oxide and alumina, and organic fillers, e.g., crosslinking polystyrene and silicone resins are exemplified.

For the purpose of highly rigidifying a support, these materials may be highly oriented, or a layer of metal, semimetal or the oxide thereof may be provided on the surface of the support.

In the invention, the thickness of polyester of the nonmagnetic support is preferably from 3 to 80 μm, more preferably from 3 to 50 μm, and especially preferably from 3 to 10 μm. The central plane average surface roughness (Ra) of the support of the side having the magnetic layer is preferably 6 nm or less, and more preferably 4 nm or less.

The Young's modulus of the nonmagnetic support in the machine direction and the transverse direction is preferably 6.0 GPa or more, and more preferably 7.0 GPa or more.

In the invention, for adjusting the central plane surface roughness Ra of the back coat layer to the range specified in the invention, the central plane surface roughness Ra of the nonmagnetic support of the back coat layer side is set at preferably from 0.8 to 1.8 nm, more preferably from 0.9 to 1.7 nm, still more preferably from 1.0 to 1.6 nm, and especially preferably from 1.1 to 1.5 nm.

A magnetic recording medium in the invention comprises a nonmagnetic support and at least a magnetic layer containing ferromagnetic powder and a binder having been provided on one side of the support, and it is preferred to provide a substantially nonmagnetic layer (a lower layer) between the nonmagnetic support and the magnetic layer.

### Magnetic Layer:

The volume of the ferromagnetic powder contained in a magnetic layer is preferably from 1,000 to 20,000 nm³, and more preferably from 2,000 to 8,000 nm³. When the volume of the ferromagnetic powder contained in a magnetic layer is in this range, the reduction of magnetic characteristics due to thermal fluctuation can be effectively restrained and at the same time good C/N (S/N) can be obtained while maintaining noise at a low level. As ferromagnetic powders, hexagonal ferrite powders are used.

The volume of acicular powder is obtained from the long axis length and the short axis length taking the shape of the powder as cylindrical.

The volume of hexagonal ferrite powder is obtained from the tabular diameter and the axis length (tabular thickness) taking the shape as a hexagonal pole.

For finding a particle size of a magnetic substance, a proper amount of a magnetic layer is peeled off. n-Butylamine is added to 30 to 70 mg of the peeled magnetic layer, and they are sealed in a glass tube, the glass tube is set on a pyrolytic apparatus and heated at 140° C. for about one day. After cooling, the content is taken out of the glass tube and centrifuged to thereby separate liquid and solid content. The separated solid content is washed with acetone to obtain a powder sample for TEM. The particles of the sample are photographed with a transmission electron microscope H-9000 (manufactured by Hitachi Limited) with magnifications of 100,000 and printed on a photographic paper in total magnifications of 500,000 to obtain a photograph of the particles. An objective magnetic particle is selected from the photograph of the particles, the outline of the particle is traced with a digitizer, and the particle size is measured with an image analyzing software KS-400 (manufactured by Carl Zeiss). The sizes of 500 particles are measured, and the measured values are averaged to obtain an average particle size.

### Ferromagnetic Hexagonal Ferrite Powder:

The examples of ferromagnetic hexagonal ferrite powders include barium ferrite, strontium ferrite, lead ferrite, calcium ferrite, and Co substitution products of these ferrites. More specifically, magnetoplumbite type barium ferrite and strontium ferrite, magnetoplumbite type ferrites having covered the particle surfaces with spinel, and magnetoplumbite type barium ferrite and strontium ferrite partially containing spinel phase can be exemplified. Ferromagnetic hexagonal ferrite powders may contain, in addition to the prescribed atoms, the following atoms, e.g., Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge and Nb. In general, ferromagnetic hexagonal ferrite powders containing the following elements can be used, e.g., Co—Zn, Co—Ti, Co—Ti—Zr, Co—Ti—Zn, Ni—Ti—Zn, Nb—Zn—Co, Sb—Zn—Co and Nb—Zn. According to starting materials and manufacturing methods, specific impurities may be contained. Preferred other atoms and the contents are the same as the case of ferromagnetic metal powders.

The particle sizes of hexagonal ferrite powders are preferably the sizes satisfying the above-specified volume. The average tabular size is less than 30 nm, preferably from 10 to 29 nm, and more preferably from 15 to 25 nm.

The average tabular ratio [the average of (tabular diameter/tabular thickness)] of hexagonal ferrite powders is preferably from 1 to 15, more preferably from 1 to 7. When the average tabular ratio is in the range of from 1 to 15, sufficient orientation can be attained while maintaining high packing density in a magnetic layer and, at the same time, the increase in noise due to stacking among particles can be prevented. The specific surface area measured by a BET method (S_{BET}) of particles in the above particle size range is preferably 40 m²/g or more, more preferably from 40 to 200 m²/g, and most preferably from 60 to 100 m²/g.

The distribution of tabular diameter-tabular thickness of hexagonal ferrite powder particles is generally preferably as narrow as possible. Tabular diameter-tabular thickness of particles can be compared in numerical values by measuring 500 particles selected randomly from TEM photographs of particles. The distributions of tabular diameter·tabular thickness of particles are in many cases not regular distributions, but when expressed in the standard deviation to the average size by calculation, σ/average size is from 0.1 to 1.0. For obtaining narrow particle size distribution, it is effective to make a particle-forming reaction system homogeneous as far as possible, and to subject particles formed to distribution improving treatment as well. For instance, a method of selectively dissolving superfine particles in an acid solution is also known.

The coercive force (Hc) of hexagonal ferrite powders can be made from 143.3 to 318.5 kA/m (from 1,800 to 4,000 Oe), but Hc is preferably from 159.2 to 238.9 kA/m (from 2,000 to 3,000 Oe), and more preferably from 191.0 to 214.9 kA/m (from 2,200 to 2,800 Oe).

Coercive force (Hc) can be controlled by the particle size (tabular diameter·tabular thickness), the kinds and amounts of the elements contained in the hexagonal ferrite powder, the substitution sites of the elements, and the particle forming reaction conditions.

The saturation magnetization (σₛ) of hexagonal ferrite powders is from 30 to 80 A·m²/kg (emu/g). Saturation magnetization (σₛ) is preferably higher, but it has the inclination of becoming smaller as particles become finer. For the purpose of the improvement of saturation magnetization (σₛ), compounding spinel ferrite to magnetoplumbite ferrite, and selection of the kind and the addition amount of elements to be contained are well known. It is also possible to use W-type hexagonal ferrite. In dispersing magnetic powders, the surfaces of the magnetic particles may be treated with dispersion media and substances compatible with the polymers. Inorganic and organic compounds are used as surface-treating agents. For example, oxides or hydroxides of Si, Al and P, various kinds of silane coupling agents and various kinds of titanium coupling agents are representative as such compounds. The addition amount of these surface-treating agents is from 0.1 to 10 mass % based on the mass of the magnetic powder. The pH of magnetic powders is also important for dispersion, and the pH is generally from 4 to 12 or so. The optimal value of pH is dependent upon the dispersion media and the polymers. Taking the chemical stability and storage stability of a medium into consideration, pH of from 6 to 11 or so is selected. The moisture content contained in magnetic powders also affects dispersion. The optimal value of the moisture content is dependent upon the dispersion media and the polymers, and generally moisture content of from 0.01 to 2.0% is selected.

The manufacturing methods of hexagonal ferrite powders include the following methods, and any of these methods can be used in the invention with no restriction: (1) a glass crystallization method comprising the steps of mixing metallic oxide which substitutes barium oxide•iron oxide•iron with boron oxide and the like as a glass-forming material so as to make a desired ferrite composition, melting and then quenching the ferrite composition to obtain an amorphous product, treating by reheating, washing and pulverizing the amorphous product to thereby obtain barium ferrite crystal powder; (2) a hydrothermal reaction method comprising the steps of neutralizing a solution of barium ferrite composition metal salt with an alkali, removing the byproducts, heating the liquid phase at 100° C. or more, washing, drying and then pulverizing the reaction product to thereby obtain barium ferrite crystal powder; and (3) a coprecipitation method comprising the steps of neutralizing a solution of barium ferrite composition metal salt with an alkali, removing the byproducts, drying and treating the system at 1,100° C. or less, and then pulverizing the reaction product to obtain barium ferrite crystal powder. Hexagonal ferrite powders may be subjected to surface treatment with Al, Si, P or oxides thereof, if necessary, and the amount of the surface-treating compound is from 0.1 to 10% based on the amount of the ferromagnetic powders. By the surface treatment, the adsorption amount of lubricant, e.g., fatty acid, preferably becomes 100 mg/m² or less. Ferromagnetic powders sometimes contain soluble inorganic ions of, e.g., Na, Ca, Fe, Ni or Sr, however, it is preferred that these inorganic ions are not substantially contained, but the properties of hexagonal powders are not particularly affected if the amount is 200 ppm or less.

According to the above manufacturing methods, hexagonal ferrite powders can be preferably used in magnetic layers of magnetic recording media. As the magnetic recording media, magnetic tapes, e.g., a videotape and a computer tape, and magnetic discs, e.g., a Floppy disc (a registered trademark) and a hard disc can be exemplified.

### Binder:

Well-known techniques connected with magnetic layer and nonmagnetic layer can be applied to the binder, lubricant, dispersant, additive, solvent, dispersing method and the others in the magnetic layer and nonmagnetic layer of a magnetic recording medium in the invention. In particular, in connection with the amounts and kinds of binders, and the amounts and kinds of additives and dispersants, well-known techniques of magnetic layer can be applied to the invention.

As the binders for use in the invention, conventionally known thermoplastic resins, thermosetting resins, reactive resins and mixtures of these resins are used. Thermoplastic resins having a glass transition temperature of from −100 to 150° C., a number average molecular weight of from 1,000 to 200,000, preferably from 10,000 to 100,000, and polymerization degree of from about 50 to 1,000 or so can be used in the invention.

The examples of thermoplastic resins include polymers or copolymers containing, as the constituting unit, vinyl chloride, vinyl acetate, vinyl alcohol, maleic acid, acrylic acid, acrylic ester, vinylidene chloride, acrylonitrile, methacrylic acid, methacrylic ester, styrene, butadiene, ethylene, vinyl butyral, vinyl acetal, or vinyl ether; polyurethane resins and various rubber resins. The examples of thermosetting resins and reactive resins include phenol resins, epoxy resins, curable type polyurethane resins, urea resins, melamine resins, alkyd resins, acrylic reactive resins, formaldehyde resins, silicone resins, epoxy-polyamide resins, mixtures of polyester resins and isocyanate prepolymers, mixtures of polyester polyol and polyisocyanate, and mixtures of polyurethane and polyisocyanate. These resins are described in detail in Plastic Handbook, published by Asakura Shoten. In addition, well-known electron beam-curable resins can also be used in each layer. The examples of these resins and the producing methods are disclosed in detail in JP-A-62-256219. These resins can be used alone or in combination, and the examples of preferred combinations include combinations of at least one selected from vinyl chloride resins, vinyl chloride-vinyl acetate copolymers, vinyl chloride-vinyl acetate-vinyl alcohol copolymers, and vinyl chloride-vinyl acetate-maleic anhydride copolymers, with polyurethane resins, and combinations of any of these resins with polyisocyanate.

Polyurethane resins having known structures, e.g., polyester polyurethane, polyether polyurethane, polyether polyester polyurethane, polycarbonate polyurethane, polyester polycarbonate polyurethane, and polycaprolactone polyurethane, can be used. Concerning every binder shown above, it is preferred that at least one or more polar groups selected from the following groups be introduced by copolymerization or addition reaction for the purpose of obtaining further excellent dispersibility and durability, e.g., —COOM, —SO₃M, —OSO₃M, —P═O(OM)₂, —O—P═O(OM)₂ (wherein M represents a hydrogen atom or an alkali metal salt group), —OH, —NR₂, —N⁺R₃ (wherein R represents a hydrocarbon group), an epoxy group, —SH, and —CN. The amount of these polar groups is preferably from 10⁻¹ to 10⁻⁸ mol/g, and more preferably from 10⁻² to 10⁻⁶ mol/g.

The specific examples of these binders that are used in the invention include VAGH, VYHH, VMCH, VAGF, VAGD, VROH, VYES, VYNC, VMCC, XYHL, XYSG, PKHH, PKHJ, PKHC and PKFE (manufactured by Dow Chemical Company) MPR-TA, MPR-TA5, MPR-TAL, MPR-TSN, MPR-TMF, MPR-T5, MPR-TM and MPR-TAO (manufactured by Nisshin Chemical Industry Co., Ltd.), 1000W, DX80, DX81, DX82, DX83 and 100FD (manufactured by Electro Chemical Industry), MR-104, MR-105, MR-110, MR-100, MR-555 and 400X-110A (manufactured by Nippon Zeon Co., Ltd.), Nippollan N2301, N2302 and N2304 (manufactured by Nippon Polyurethane Industry Co., Ltd.), Pandex T-5105, T-R3080, T-5201, Burnock D-400, D-210-80, Crisvon 6109 and 7209 (manufactured by Dainippon Ink and Chemicals Inc.), Vylon UR8200, UR8300, UR8700, RV530 and RV280 (manufactured by Toyobo Co., Ltd.), Daipheramine 4020, 5020, 5100, 5300, 9020, 9022 and 7020 (manufactured by Dainichiseika Color & Chemicals Mfg. Co., Ltd), MX5004 (manufactured by Mitsubishi Chemical Corporation), Sanprene SP-150 (manufactured by Sanyo Chemical Industries, Ltd.), Saran F310 and F210 (manufactured by Asahi Kasei Corporation).

The amount of the binders for use in a nonmagnetic layer and a magnetic layer in the invention is preferably from 5 to 50 mass % based on the amount of the nonmagnetic powder or the magnetic powder, and more preferably from 10 to 30 mass %. When vinyl chloride resins are used as the binder, the amount is from 5 to 30 mass %, when polyurethane resins are used, the amount is from 2 to 20 mass %, and it is preferred that polyisocyanate is used within the range of from 2 to 20 mass % in combination with these binders. However, for instance, when the corrosion of head is caused by a trace amount of chlorine due to dechlorination, it is also possible to use polyurethane alone or a combination of polyurethane and isocyanate alone. When polyurethane is used in the invention, it is preferred that the polyurethane has a glass transition temperature of from −50 to 150° C., preferably from 0 to 100° C., breaking elongation of from 100 to 2,000%, breaking stress of from 0.05 to 10 kg/mm² (from 0.49 to 98 MPa), and a yielding point of from 0.05 to 10 kg/mm² (from 0.49 to 98 MPa).

The examples of polyisocyanates for use in the invention include isocyanates, e.g., tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, and triphenylmethane triisocyanate; reaction products of these isocyanates with polyalcohols; and polyisocyanates formed by condensation reaction of isocyanates. These polyisocyanates are commercially available under the trade names of Coronate L, Coronate HL, Coronate 2030, Coronate 2031, Millionate MR and Millionate MTL (manufactured by Nippon Polyurethane Industry Co., Ltd.), Takenate D-102, Takenate D-110N, Takenate D-200 and Takenate D-202 (manufactured by Takeda Chemical Industries, Ltd.), and Desmodur L, Desmodur IL, Desmodur N and Desmodur HL (manufactured by Sumitomo Bayer Co., Ltd.). These polyisocyanates may be used alone, or in combination of two or more in each layer taking the advantage of a difference in curing reactivity.

If necessary, additives can be added to a magnetic layer in the invention. As the additives, an abrasive, a lubricant, a dispersant, an auxiliary dispersant, a mildewproofing agent, an antistatic agent, an antioxidant, a solvent and carbon black can be exemplified. The examples of additives usable in the invention include molybdenum disulfide, tungsten disulfide, graphite, boron nitride, graphite fluoride, silicone oil, silicone having a polar group, fatty acid-modified silicone, fluorine-containing silicone, fluorine-containing alcohol, fluorine-containing ester, polyolefin, polyglycol, polyphenyl ether, aromatic ring-containing organic phosphonic acid, e.g., phenylphosphonic acid, benzylphosphonic acid, phenethylphosphonic acid, α-methylbenzylphosphonic acid, 1-methyl-1-phenethylphosphonic acid, diphenylmethyl-phosphonic acid, biphenylphosphonic acid, benzylphenyl-phosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, nonylphenylphosphonic acid, and alkali metal salts of these organic phosphonic acids, alkyl-phosphonic acid, e.g., octylphosphonic acid, 2-ethylhexyl-phosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, isoeicosylphosphonic acid, and alkali metal salts of these alkylphosphonic acids, aromatic phosphoric ester, e.g., phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, toluyl phosphate, xylyl phosphate, ethylphenyl phosphate, cumenyl phosphate, propylphenyl phosphate, butylphenyl phosphate, heptylphenyl phosphate, octylphenyl phosphate, nonylphenyl phosphate, and alkali metal salts of these aromatic phosphoric esters, alkyl phosphoric ester, e.g., octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, isoeicosyl phosphate, and alkali metal salts of these alkyl phosphoric esters, alkylsulfonic esters and alkali metal salts of alkylsulfonic esters, fluorine-containing alkylsulfuric esters and alkali metal salts thereof, monobasic fatty acid having from 10 to 24 carbon atoms (which may contain an unsaturated bond or may be branched), e.g., lauric acid, myristic acid, palmitic acid, stearic acid, behenic acid, butyl stearate, oleic acid, linoleic acid, linolenic acid, elaidic acid, erucic acid, and alkali metal salt of these monobasic fatty acids, fatty acid monoester, fatty acid diester or polyhydric fatty acid ester composed of monobasic fatty acid having from 10 to 24 carbon atoms (which may contain an unsaturated bond or may be branched), e.g., butyl stearate, octyl stearate, amyl stearate, isooctyl stearate, octyl myristate, butyl laurate, butoxyethyl stearate, anhydro-sorbitan monostearate, or anhydrosorbitan tristearate, and any one of mono-, di-, tri-, tetra-, penta- or hexa-alcohols having from 2 to 22 carbon atoms (which may contain an unsaturated bond or may be branched), alkoxy alcohol having from 2 to 22 carbon atoms (which may contain an unsaturated bond or may be branched), and monoalkyl ether of alkylene oxide polymerized product, fatty acid amide having from 2 to 22 carbon atoms, and aliphatic amines having from 8 to 22 carbon atoms. Besides the above hydrocarbon groups, those having a nitro group, or an alkyl, aryl, or aralkyl group substituted with a group other than a hydrocarbon group, such as halogen-containing hydrocarbon, e.g., F, Cl, Br, CF₃, CCl₃, CBr₃, may be used.

In addition, nonionic surfactants, e.g., alkylene oxide, glycerol, glycidol, alkylphenol ethylene oxide adduct, etc., cationic surfactants, e.g., cyclic amine, ester amide, quaternary ammonium salts, hydantoin derivatives, heterocyclic rings, phosphoniums and sulfoniums, anionic surfactants containing an acid group, e.g., carboxylic acid, sulfonic acid or a sulfuric ester group, and amphoteric surfactants, e.g. amino acids, aminosulfonic acids, sulfuric or phosphoric esters of amino alcohol, and alkylbetaine can also be used. The details of these surfactants are described in detail in Kaimen Kasseizai Binran (Handbook of Surfactants), Sangyo Tosho Publishing Co. Ltd.

These lubricants and antistatic agents need not be 100% pure and they may contain impurities such as isomers, unreacted products, byproducts, decomposed products and oxides, in addition to the main components. However, the content of such impurities is preferably 30 mass % or less, and more preferably 10 mass % or less.

As the specific examples of these additives, e.g., NAA-102, castor oil hardened fatty acid, NAA-42, cation SA, Naimeen L-201, Nonion E-208, Anon BF and Anon LG (manufactured by Nippon Oils and Fats Co., Ltd.), FAL-205 and FAL-123 (manufactured by Takemoto Oil & Fat), Enujerubu OL (manufactured by New Japan Chemical Co., Ltd.), TA-3 (manufactured by Shin-Etsu Chemical Co., Ltd.), Armide P (manufactured by Lion Armour Co., Ltd.), Duomeen TDO (manufactured by Lion Akzo Chemicals), BA-41G (manufactured by The Nisshin OilliO Group, Ltd.), Profan 2012E, Newpole PE61, Ionet MS-400 (manufactured by Sanyo Chemical Industries Ltd.) are exemplified.

Carbon blacks can be added to a magnetic layer in the invention, if necessary. Carbon blacks usable in a magnetic layer are furnace blacks for rubbers, thermal blacks for rubbers, carbon blacks for coloring, and acetylene blacks. Carbon blacks for use in the invention preferably have a specific surface area of from 5 to 500 m²/g, a DBP oil absorption amount of from 10 to 400 ml/100 g, a particle size of from 5 to 300 nm, a pH value of from 2 to 10, a moisture content of from 0.1 to 10%, and a tap density of from 0.1 to 1 g/ml.

The specific examples of carbon blacks for use in the invention include BLACKPEARLS 2000, 1300, 1000, 900, 905, 800, 700, and VULCAN XC-72 (manufactured by Cabot Co., Ltd.), #80, #60, #55, #50 and #35 (manufactured by ASAHI CARBON CO., LTD.), #2400B, #2300, #900, #1000, #30, #40 and #10B (manufactured by Mitsubishi Chemical Corporation), CONDUCTEX SC, RAVEN 150, 50, 40, 15, and RAVEN-MT-P (manufactured by Columbia Carbon Co., Ltd.) and Ketjen Black EC (manufactured by Ketjen Black International Co.). Carbon blacks may be surface-treated with a dispersant, may be grafted with resins, or a part of the surface may be graphitized in advance before use. Carbon blacks may be previously dispersed in a binder before being added to a magnetic coating solution. Carbon blacks can be used alone or in combination. It is preferred to use carbon blacks in an amount of from 0.1 to 30 mass % based on the mass of the magnetic powder. Carbon blacks can serve various functions such as prevention of the static charge and reduction of the friction coefficient of a magnetic layer, impartation of a light-shielding property to a magnetic layer, and improvement of the film strength of a magnetic layer. Such functions vary by the kind of the carbon black to be used. Accordingly, it is of course possible in the invention to select and determine the kinds, amounts and combinations of carbon blacks to be added to a magnetic layer and a nonmagnetic layer on the basis of the above-described various properties such as the particle size, the oil absorption amount, the electrical conductance and the pH value, or these should be rather optimized in each layer. In connection with carbon blacks usable in a magnetic layer in the invention, Carbon Black Binran (Handbook of Carbon Blacks), edited by Carbon Black Association can be referred to.

### Abrasive:

As abrasives which are used in the invention, well-known materials essentially having a Mohs' hardness of 6 or more are used alone or in combination, e.g., α-alumina having an α-conversion rate of 90% or more, β-alumina, silicon carbide, chromium oxide, cerium oxide, α-iron oxide, corundum, artificial diamond, silicon nitride, silicon carbide, titanium carbide, titanium oxide, silicon dioxide, and boron nitride are exemplified. Composites composed of these abrasives (abrasives obtained by surface-treating with other abrasives) may also be used. Compounds or elements other than the main component are often contained in these abrasives, but the intended effect can be achieved so long as the content of the main component is 90% or more. These abrasives preferably have a particle size of from 0.01 to 2 μm. In particular, for improving electromagnetic characteristics, abrasives having narrow particle size distribution are preferably used. For improving durability, a plurality of abrasives each having a different particle size may be combined according to necessity, or a single abrasive having a broad particle size distribution may be used so as to attain the same effect as such a combination. Abrasives for use in the invention preferably have a tap density of from 0.3 to 2 g/ml, a moisture content of from 0.1 to 5%, a pH value of from 2 to 11, and a specific surface area of from 1 to 30 m²/g. The figure of the abrasives for use in the invention may be any of acicular, spherical, die-like and tabular figures, but abrasives having a figure partly with edges are preferred for their high abrasive property. The specific examples of abrasives include AKP-12, AKP-15, AKP-20, AKP-30, AKP-50, HIT-20, HIT-30, HIT-55, HIT-60, HIT-70, HIT-80 and HIT-100 (manufactured by Sumitomo Chemical Co., Ltd.), ERC-DBM, HP-DMB and HPS-DBM (manufactured by Reynolds International Inc.), WA10000 (manufactured by Fujimi Kenmazai K.K.), UB20 (manufactured by Uyemura & Co., Ltd.), G-5, Chromex U2 and Chromex U1 (manufactured by Nippon Chemical Industrial Co., Ltd.), TF100 and TF140 (manufactured by Toda Kogyo Corp.), β-Random Ultrafine (manufactured by Ibiden Co., Ltd.), and B-3 (manufactured by Showa Mining Co., Ltd.). These abrasives can also be added to a nonmagnetic layer, if necessary. By adding abrasives into a nonmagnetic layer, it is possible to control surface configuration or to prevent abrasives from protruding. The particle sizes and the amounts of these abrasives to be added to a magnetic layer and a nonmagnetic layer should be selected at optimal values.

Well-known organic solvents can be used in the invention. The organic solvents shown below can be used in an optional rate in the invention, for example, ketones, e.g., acetone, methyl ethyl ketone, methyl isobutyl ketone, diisobutyl ketone, cyclohexanone, isophorone, and tetrahydrofuran; alcohols, e.g., methanol, ethanol, propanol, butanol, isobutyl alcohol, isopropyl alcohol, and methylcyclohexanol; esters, e.g., methyl acetate, butyl acetate, isobutyl acetate, isopropyl acetate, ethyl lactate, and glycol acetate; glycol ethers, e.g., glycol dimethyl ether, glycol monoethyl ether, and dioxane; aromatic hydrocarbons, e.g., benzene, toluene, xylene, cresol, and chlorobenzene; chlorinated hydrocarbons, e.g., methylene chloride, ethylene chloride, carbon tetrachloride, chloroform, ethylene chlorohydrin, and dichlorobenzene; and N,N-dimethyl-formamide and hexane are exemplified.

These organic solvents need not be 100% pure and they may contain impurities such as isomers, unreacted products, side reaction products, decomposed products, oxides, and water in addition to their main components. However, the content of such impurities is preferably 30% or less, and more preferably 10% or less. It is preferred that the same kind of organic solvents are used in a magnetic layer and a nonmagnetic layer, but the addition amounts may differ. It is preferred to use organic solvents having high surface tension (such as cyclohexanone, dioxane and the like) in a nonmagnetic layer to thereby increase coating stability. Specifically, it is important for the arithmetic mean value of the surface tension of the composition of the solvent in an upper layer not to be lower than the arithmetic mean value of the surface tension of the composition of the solvent in a nonmagnetic layer. For improving dispersibility, the porality is preferably strong in a certain degree, and it is preferred that solvents having a dielectric constant of 15 or more account for 50% or more of the compositions of the solvents. The dissolution parameter is preferably from 8 to 11.

The kinds and the amounts of these dispersants, lubricants and surfactants for use in the invention can be used differently in a magnetic layer and a nonmagnetic layer described later, according to necessity. Although these are not limited to the examples described here, dispersants have a property of adsorbing or bonding by the polar groups, and dispersants are adsorbed or bonded by the polar groups mainly to the surfaces of ferromagnetic metal powder particles in a magnetic layer and mainly to the surfaces of nonmagnetic powder particles in a nonmagnetic layer, and it is supposed that, for example, an organic phosphorus compound once adsorbed is hardly desorbed from the surface of metal or metallic compound. Accordingly, the surfaces of ferromagnetic metal powder particles or nonmagnetic powder particles are in the state of being covered with alkyl groups or aromatic groups, so that the affinity of the ferromagnetic metal powder or nonmagnetic powder to the binder components is improved, and further the dispersion stability of the ferromagnetic metal powder or nonmagnetic powder is also improved. In addition, since lubricants are present in a free state, it is effective to use fatty acids each having a different melting point in a nonmagnetic layer and a magnetic layer so as to prevent bleeding out of the fatty acids to the surface, or esters each having a different boiling point and different polarity so as to prevent bleeding out of the esters to the surface. Also it is effective that the amount of surfactants is controlled so as to improve the coating stability, or the amount of lubricant in a nonmagnetic layer is made larger so as to improve the lubricating effect. All or a part of the additives to be used in the invention may be added to a magnetic coating solution or a nonmagnetic coating solution in any step of preparation. For example, additives may be blended with ferromagnetic powder before a kneading step, may be added in a step of kneading ferromagnetic powder, a binder and a solvent, may be added in a dispersing step, may be added after a dispersing step, or may be added just before coating.

### Nonmagnetic Layer:

A nonmagnetic layer is described in detail below. A magnetic recording medium in the invention may have a nonmagnetic layer containing a binder and nonmagnetic powder on a nonmagnetic support. The nonmagnetic powder usable in a nonmagnetic layer may be an inorganic substance or an organic substance. Carbon black can also be used in a nonmagnetic layer. As the inorganic substances, e.g., metal, metallic oxide, metallic carbonate, metallic sulfate, metallic nitride, metallic carbide and metallic sulfide are exemplified.

Specifically, titanium oxide, e.g., titanium dioxide, cerium oxide, tin oxide, tungsten oxide, ZnO, ZrO₂, SiO₂, Cr₂O₃, α-alumina having an α-conversion rate of from 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide can be used alone or in combination of two or more kinds. α-Iron oxide and titanium oxide are preferred.

The shape of nonmagnetic powders may be any of an acicular, spherical, polyhedral and tabular shapes. The crystallite size of nonmagnetic powders is preferably from 4 to 500 nm, and more preferably from 40 to 100 nm. When the crystallite size of nonmagnetic powders is in the range of from 4 to 500 nm, dispersion can be performed easily and preferred surface roughness can be obtained. The average particle size of nonmagnetic powders is preferably from 5 to 500 nm, but if necessary, a plurality of nonmagnetic powders each having a different particle size may be combined, or single nonmagnetic powder may have broad particle size distribution so as to attain the same effect as such a combination. Nonmagnetic powders particularly preferably have an average particle size of from 10 to 200 nm. When the average particle size is in the range of from 5 to 500 nm, dispersion can be performed easily and preferred surface roughness can be obtained.

Nonmagnetic powders have a specific surface area of preferably from 1 to 150 m²/g, more preferably from 20 to 120 m²/g, and still more preferably from 50 to 100 m²/g. When the specific surface area is in the range of from 1 to 150 m²/g, preferred surface roughness can be secured and dispersion can be effected with a desired amount of binder. Nonmagnetic powders have an oil absorption amount using dibutyl phthalate (DBP) of generally from 5 to 100 ml/100 g, preferably from 10 to 80 ml/100 g, and more preferably from 20 to 60 ml/100 g; a specific gravity of preferably from 1 to 12, and more preferably from 3 to 6; a tap density of preferably from 0.05 to 2 g/ml, more preferably from 0.2 to 1.5 g/ml, when the tap density is in the range of 0.05 to 2 g/ml, particles hardly scatter and handling is easy, and the powders tend not to adhere to the apparatus; pH of preferably from 2 to 11, especially preferably between 6 and 9, when the pH is in the range of from 2 to 11, the friction coefficient does not increase under high temperature and high humidity or due to liberation of fatty acid; a moisture content of generally from 0.1 to 5 mass %, preferably from 0.2 to 3 mass %, and more preferably from 0.3 to 1.5 mass %, when the moisture content is in the range of from 0.1 to 5 mass %, good dispersion is ensured and the viscosity of the coating solution after dispersion stabilizes. The ignition loss of nonmagnetic powders is preferably 20 mass % or less, and nonmagnetic powders showing small ignition loss are preferred.

When nonmagnetic powder is inorganic powder, Mohs' hardness is preferably from 4 to 10. When Mohs' hardness is in the range of from 4 to 10, durability can be secured. Nonmagnetic powder has adsorption amount of a stearic acid of preferably from 1 to 20 μmol/m², more preferably from 2 to 15 μmol/m², and heat of wetting to water at 25° C. of preferably from 200 to 600 erg/cm² (from 200 to 600 mJ/m²). Solvents in this range of heat of wetting can be used. The number of the molecules of water at the surface of nonmagnetic powder at 100 to 400° C. is preferably from 1 to 10/100 Å. The pH of isoelectric point in water is preferably from 3 to 9. The surfaces of nonmagnetic powders are preferably covered with A1₂O₃, SiO₂, TiO₂, ZrO₂, SnO₂, Sb₂O₃ or ZnO by surface treatment. Al₂O₃, SiO₂, TiO₂ and ZrO₂ are especially preferred in dispersibility, and Al₂O₃, SiO₂ and ZrO₂ are still more preferred. Surface-covering compounds can be used in combination or can be used alone. According to purposes, nonmagnetic powder particles may have a layer subjected to surface treatment by coprecipitation.

Alternatively, surfaces of particles may be covered with alumina previously, and then the alumina-covered surfaces may be covered with silica, or vice versa, according to purposes. A surface-covered layer may be a porous layer, if necessary, but a homogeneous and dense surface is generally preferred.

The specific examples of the nonmagnetic powders for use in a nonmagnetic layer according to the invention include Nanotite (manufactured by Showa Denko k.k.), HIT-100 and ZA-G1 (manufactured by Sumitomo Chemical Co., Ltd.), DPN-250, DPN-250BX, DPN-245, DPN-270BX, DPB-550BX and DPN-550RX (manufactured by Toda Kogyo Corp.), titanium oxides TTO-51B, TTO-55A, TTO-55B, TTO-55C, TTO-55S, TTO-55D, SN-100, MJ-7, α-iron oxides E270, E271 and E300 (manufactured by Ishihara Sangyo Kaisha Ltd.), STT-4D, STT-30D, STT-30 and STT-65C (manufactured by Titan Kogyo Kabushiki Kaisha), MT-100S, MT-100T, MT-150W, MT-500B, T-600B, T-100F and T-500HD (manufactured by TAYCA CORPORATION), FINEX-25, BF-1, BF-10, BF-20 and ST-M (manufactured by Sakai Chemical Industry Co., Ltd.), DEFIC-Y and DEFIC-R (manufactured by Dowa Mining Co., Ltd.), AS2BM and TiO₂ P25 (manufactured by AEROSIL) 100A and 500A (manufactured by Ube Industries, Ltd.), and Y-LOP and calcined products of Y-LOP (manufactured by Titan Kogyo Kabushiki Kaisha). Especially preferred nonmagnetic powders are titanium dioxide and α-iron oxide.

Surface electric resistance and light transmittance can be reduced by the addition of carbon blacks to a nonmagnetic layer with nonmagnetic powder and a desired micro Vickers hardness can be obtained at the same time. The micro Vickers hardness of a nonmagnetic layer is generally from 25 to 60 kg/mm² (from 245 to 588 MPa), preferably from 30 to 50 kg/mm² (from 294 to 940 MPa) for adjusting head touch. Micro Vickers hardness can be measured using a triangular pyramid needle of diamond having an angle of sharpness of 80° and radius of the tip of 0.1 μm attached at the tip of an indenter using a membrane hardness meter HMA-400 (manufactured by NEC Corporation). In regard to the details of micro Vickers hardness, Hakumaku no Rikigakuteki Tokusei Hyouka Gijutsu (Evaluation Techniques of Dynamical Characteristics of Membranes) Realize Advanced Technology Limited, can be referred to. Light transmittance is standardized such that the absorption of infrared rays of wavelength of about 900 nm is generally 3% or less, e.g., the light transmittance of a magnetic tape for VHS is 0.8% or less. For this purpose, furnace blacks for rubbers, thermal blacks for rubbers, carbon blacks for coloring, and acetylene blacks can be used.

Carbon blacks for use in a nonmagnetic layer in the invention have a specific surface area of preferably from 100 to 500 m²/g, more preferably from 150 to 400 m²/g, DBP oil absorption of preferably from 20 to 400 ml/100 g, more preferably from 30 to 200 ml/100 g, a particle size of preferably from 5 to 80 nm, more preferably from 10 to 50 nm, and still more preferably from 10 to 40 nm, pH of preferably from 2 to 10, a moisture content of preferably from 0.1 to 10%, and a tap density of preferably from 0.1 to 1 g/ml.

The specific examples of carbon blacks for use in a nonmagnetic layer in the invention include BLACKPEARLS 2000, 1300, 1000, 900, 800, 880, 700, and VULCAN XC-72 (manufactured by Cabot Co., Ltd.), #3050B, #3150B, #3250B, #3750B, #3950B, #950, #650B, #970B, #850B and MA-600 (manufactured by Mitsubishi Chemical Corporation), CONDUCTEX SC, RAVEN 8800, 8000, 7000, 5750, 5250, 3500, 2100, 2000, 1800, 1500, 1255 and 1250 (manufactured by Columbia Carbon Co., Ltd.), and Ketjen Black EC (manufactured by Ketjen Black International Co.).

The carbon blacks may previously be surface-treated with a dispersant, may be grafted with a resin, or a part of the surface thereof may be graphitized in advance before use. Carbon blacks may be previously dispersed in a binder before addition to a coating solution. These carbon blacks can be used within the range not exceeding 50 mass % based on the above inorganic powders and not exceeding 40 mass % based on the total mass of the nonmagnetic layer. These carbon blacks can be used alone or in combination. Regarding the carbon blacks for use in a nonmagnetic layer in the invention, for example, Carbon Black Binran (Handbook of Carbon Blacks), compiled by Carbon Black Association, can be referred to.

Organic powders can be added to a nonmagnetic layer according to purpose. The examples of such organic powders include acryl styrene resin powder, benzoguanamine resin powder, melamine resin powder and a phthalocyanine pigment. In addition to the above, polyolefin resin powder, polyester resin powder, polyamide resin powder, polyimide resin powder and polyethylene fluoride resin powder can also be used. The producing methods of organic powders disclosed in JP-A-62-18564 and JP-A-60-255827 can be used in the invention.

The binder resins, lubricants, dispersants, additives, solvents, dispersing methods, etc., used in a magnetic layer can be used in a nonmagnetic layer. In particular, in connection with the amounts and kinds of binder resins, additives, and the amounts and kinds of dispersants, well-known prior techniques respecting the magnetic layer can be applied to a nonmagnetic layer in the invention.

Further, a magnetic recording medium in the invention may be provided with an undercoat layer. Adhesion of a support and a magnetic layer or a nonmagnetic layer can be improved by providing an undercoat layer. Polyester resins soluble in a solvent are used as the undercoat layer.

### Back Coat Layer:

In a magnetic recording medium in the invention, a back coat layer is provided on the other side of the nonmagnetic support. It is preferred for the back coat layer to contain carbon black and inorganic powder. In connection with binders and various kinds of additives, the prescriptions in the magnetic layer and the nonmagnetic layer are applied to the back coat layer. The thickness of the back coat layer is preferably 0.9 μm or less, and more preferably from 0.1 to 0.7 μm.

The prescription of the back coat layer in the invention is preferably the same as that of the nonmagnetic layer, by which thermal shrinkage of the back coat layer coincides with thermal shrinkage of the nonmagnetic layer in calendering treatment and thermo-treatment processes generally carried out in the manufacturing process of a magnetic recording medium, so that fluctuation of the magnetic layer surface can further be restrained.

### Layer Constitution:

As described above, the thickness of the nonmagnetic support of a magnetic recording medium in the invention is preferably from 3 to 80 μm, more preferably from 3 to 50 μm, and especially preferably from 3 to 10 μm. When an undercoat layer is provided between the nonmagnetic support and the nonmagnetic layer or the magnetic layer, the thickness of the undercoat layer is preferably from 0.01 to 0.8 μm, and more preferably from 0.02 to 0.6 μm.

The thickness of a magnetic layer is optimized according to the saturation magnetization amount of the magnetic head used, the head gap length, and the recording signal zone, and is preferably from 10 to 150 nm, more preferably from 20 to 120 nm, still more preferably from 30 to 100 nm, and especially preferably from 30 to 80 nm. The fluctuation of a magnetic layer thickness is preferably not more than ±50%, and more preferably not more than ±30%. It is sufficient that a magnetic layer comprises at least one layer, but it may be separated to two or more layers respectively having different magnetic characteristics, and well-known constitutions connected with multilayer magnetic layer can be applied to the invention.

The thickness of a nonmagnetic layer in the invention is preferably from 0.1 to 3.0 μm, more preferably from 0.3 to 2.0 μm, and still more preferably from 0.5 to 1.5 μm. The nonmagnetic layer of a magnetic recording medium in the invention reveals the effect of the invention so long as it is substantially a nonmagnetic layer even if, or intentionally, it contains a small amount of magnetic powder as impurity, which is as a matter of course regarded as essentially the same constitution as a magnetic recording medium in the invention. The term “essentially the same constitution” means that the residual magnetic flux density of the nonmagnetic layer is 10 mT or less or the coercive force of the nonmagnetic layer is 7.96 kA/m (100 Oe) or less, preferably the residual magnetic flux density and the coercive force are zero.

### Manufacturing Method:

The manufacturing process of a magnetic layer coating solution, a nonmagnetic layer coating solution or a back coat layer coating solution of a magnetic recording medium in the invention comprises at least a kneading process, a dispersing process, and a blending process to be carried out optionally before and/or after the kneading and dispersing processes. Each of these processes may be composed of two or more separate stages. All of the materials such as ferromagnetic metal powder, nonmagnetic powder, a binder, carbon black, an abrasive, an antistatic agent, a lubricant and a solvent for use in the invention may be added at any process and any time. Each material may be added at two or more processes dividedly. For example, polyurethane can be added dividedly at a kneading process, a dispersing process, or a blending process for adjusting viscosity after dispersion. For achieving the object of the invention, conventionally known techniques can be used partly in the above processes. Powerful kneading machines such as an open kneader, a continuous kneader, a pressure kneader or an extruder are preferably used in a kneading process. These kneading treatments are disclosed in detail in JP-A-1-106338 and JP-A-1-79274. For dispersing a magnetic layer coating solution, a nonmagnetic layer coating solution, or a back coat layer coating solution, glass beads can be used, but dispersing media having a higher specific gravity, e.g., zirconia beads, titania beads and steel beads are preferably used. Optimal particle size and packing rate of these dispersing media have to be selected. Well-known dispersers can be used in the invention.

In the manufacturing method of a magnetic recording medium in the invention, a magnetic layer is formed by coating a magnetic layer coating solution in a prescribed thickness on the surface of a nonmagnetic support under running. A plurality of magnetic layer coating solutions may be coated successively or simultaneously multilayer-coated, or a nonmagnetic layer coating solution and a magnetic layer coating solution may be coated successively or multilayer-coated simultaneously. For coating the above magnetic layer coating solution or nonmagnetic layer coating solution, air doctor coating, blade coating, rod coating, extrusion coating, air knife coating, squeeze coating, impregnation coating, reverse roll coating, transfer roll coating, gravure coating, kiss coating, cast coating, spray coating and spin coating can be used. These coating methods are described, e.g., in Saishin Coating Gijutsu (The Latest Coating Techniques), Sogo Gijutsu Center Co. (May 31, 1983).

In the case of a magnetic tape, a coated layer of a magnetic layer coating solution may be subjected to magnetic field orientation treatment by a cobalt magnet and a solenoid and the ferromagnetic powder contained in the coated layer of the magnetic layer coating solution. In the case of a magnetic disc, there are cases where isotropic orienting property can be sufficiently obtained without performing orientation by using orientating apparatus, but it is preferred to use known random orientation apparatus, e.g., disposition of cobalt magnets diagonally and alternately, or application of an alternating current magnetic field with a solenoid. In the case of ferromagnetic metal powder, isotropic orientation is generally preferably in-plane two dimensional random orientation, but the orientation can be made three dimensional random orientation by applying perpendicular factor. It is also possible to impart isotropic magnetic characteristics in the circumferential direction by perpendicular orientation using well-known methods, e.g., using different pole and opposed magnets. In particular, when high density recording is carried out, perpendicular orientation is preferred. Circumferential orientation can also be obtained using spin coating.

It is preferred that the drying position of a coated film be controlled by controlling the temperature and the amount of drying air and coating rate. Coating rate is preferably from 20 to 1,000 m/min and the temperature of drying air is preferably 60° C. or more. Proper degree of preliminary drying can be performed before entering a magnet zone.

The thus obtained web is once wound around a winding roll, and then unwound from the winding roll and subjected to calendering treatment.

In calendering treatment, for example, a super calender roll is used. By calendering treatment, surface smoothness is improved, the voids generated by removal of the solvent in drying disappear, and the packing rate of the ferromagnetic metal powder in the magnetic layer increases, so that a magnetic recording medium having high electromagnetic characteristics can be obtained. It is preferred that calendering treatment is carried out with changing calendering treatment conditions according to the surface smoothness of web.

The value of glossiness of a web generally lowers from the core side of the winding roll toward the outside, and sometimes there is fluctuation in quality in the machine direction. Incidentally, it is known that the value of glossiness is mutually related (proportional relationship) with surface roughness Ra. Accordingly, if calendering treatment condition, for example, calender roll pressure, is not varied and maintained constant throughout calendering treatment process, that is, if no countermeasure is taken regarding the difference in smoothness generated in the machine direction due to winding of web, fluctuation in quality also occurs in the machine direction of the finished product.

Accordingly, it is preferred to set off the difference in smoothness generated in the machine direction due to winding of web by varying calendering treatment condition, for example, calender roll pressure, in calendering treatment process. Specifically, it is preferred to diminish calender roll pressure from the core side toward the outside of the web that is unwound from the winding roll. It has been found from the examination of the present inventors that the value of glossiness lowers when calender roll pressure is reduced (smoothness lowers). Accordingly, by varying calender roll pressure, the difference in smoothness generated in the machine direction due to winding of web is set off, and a finished product free from fluctuation in quality in the machine direction can be obtained.

An example of varying calender roll pressure is described above, and besides the above, a finished product free from fluctuation in quality can be obtained by controlling calender roll temperature, calender roll speed, or calender roll tension. Considering the characteristics of a coating type magnetic recording medium, it is preferred to control calender roll pressure or calender roll temperature. The surface smoothness of a finished product lowers by decreasing calender roll pressure or calender roll temperature. Contrary to this, the surface smoothness of a finished product increases by rising calender roll pressure or calender roll temperature.

Different from the above, a magnetic recording medium obtained after calendering treatment may be subjected to thermo-treatment to thereby accelerate thermosetting. Such thermo-treatment may be arbitrarily determined by the prescription of compounding of a magnetic layer coating solution, and the temperature of thermo-treatment is from 35 to 100° C., and preferably from 50 to 80° C. The time of thermo-treatment is from 12 to 72 hours, and preferably from 24 to 48 hours.

Heat resisting plastic rolls, e.g., epoxy, polyimide, polyamide, polyimideamide and the like are used as calender rolls. A metal roll can also be used in the treatment.

The central plane surface roughness Ra of the magnetic layer of a magnetic recording medium in the invention is very excellent as smooth as from 1.0 to 2.5 nm. The central plane surface roughness Ra of the magnetic layer is more preferably from 1.2 to 2.3 nm, and especially preferably from 1.4 to 2.2 nm.

The central plane surface roughness Ra of the back coat layer of a magnetic recording medium in the invention is from 2.0 to 4.0 nm, preferably from 2.5 to 4.0 nm, and especially preferably from 3.0 to 3.6 nm.

By specifying the central plane surface roughness Ra's of the magnetic layer and the back coat layer in the above ranges, the surface roughness of the back coat layer is not imprinted on the magnetic layer side when the back coat layer and the magnetic layer are brought into contact with each other, and running durability of the back coat layer side can also be ensured.

The glass transition point Tg of the coated layers including the magnetic layer and the nonmagnetic layer of a magnetic recording medium in the invention is from 75 to 100° C., preferably from 80 to 95° C., and more preferably from 85 to 95° C.

The glass transition point Tg of the back coat layer of a magnetic recording medium in the invention is from 75 to 100° C., preferably from 80 to 95° C., and more preferably from 85 to 95° C.

The ratio of the Young's modulus of the magnetic layer (Ym) to the Young's modulus of the back coat layer (Yb), (R=Ym/Yb), of a magnetic recording medium in the invention is preferably from 0.8 to 1.20, more preferably from 0.85 to 1.15, and still more preferably from 0.90 to 1.10.

By specifying the glass transition point Tg of the coated layers and the back coat layer, and the ratio of the Young's modulus of the magnetic layer to the back coat layer (R) in the above ranges, fluctuation of the magnetic layer surface due to thermal shrinkage of the magnetic layer side and the back coat layer side can be restrained in calendering treatment and thermo-treatment processes generally carried out in the manufacturing process of a magnetic recording medium.

Accordingly, by specifying the kind and size of the ferromagnetic powder, the central plane surface roughness Ra of the magnetic layer, the central plane surface roughness Ra of the back coat layer, the glass transition point Tg of the coated layers, the glass transition point Tg of the back coat layer, and the ratio of the Young's modulus of the magnetic layer (Ym) to the Young's modulus of the back coat layer (Yb), (R=Ym/Yb), the smoothness of a magnetic layer that is sufficient to satisfy high density recording required at present can be achieved, thus the invention can provide a magnetic recording medium having high electromagnetic characteristics.

Central plane surface roughness Ra can be controlled by the control of the surface property of a support with fillers and by the surface configurations of the rolls of calendering treatment.

Glass transition point Tg and Young's modulus can be controlled by the kind and amount of a binder, the amount of a curing agent and the like.

Central plane surface roughness Ra in the invention is a value measured with a digital optical profiler HD2000 (manufactured by WYKO) on the condition of cut-off value of 160 nm and the area of 242.4 μm×184.2 μm.

The temperature dependency of dynamic viscoelasticity was measured by frequency of 110 Hz at a rate of temperature increase of 3° C./min, and the peak of the obtained temperature dependency curve of the loss elastic modulus E″ is taken as glass transition point Tg.

Young's modulus is a value measured with a tensile tester, and when the magnetic recording medium is in the form of a tape, Young's modulus is a value in the machine direction. When the magnetic recording medium is in the form of a tape, the Young's modulus of the whole of the magnetic tape is measured first, and then the Young's modulus of the magnetic tape after peeling the back coat layer alone is measured, and the Young's modulus of the back coat layer is found from the difference of these Young's moduli.

The glass transition point Tg of the nonmagnetic layer is preferably from 0 to 180° C. The loss elastic modulus of the nonmagnetic layer is preferably in the range of from 1×10⁷ to 8×10⁸ Pa(1×10⁸ to 8×10⁹ dyne/cm²), and the loss tangent is preferably 0.2 or less. When the loss tangent is too large, adhesion failure is liable to occur. It is preferred that these thermal and mechanical characteristics are almost equal in every direction of in-plane of a medium with difference of not more than 10%.

As the conditions of calendering treatment adopted for a magnetic recording medium in the invention, the temperature of calender rolls is in the range of preferably from 60 to 100° C., more preferably from 70 to 100° C., and especially preferably from 80 to 100° C., the pressure is in the range of preferably from 100 to 500 kg/cm (from 98 to 490 kN/m), more preferably from 200 to 450 kg/cm (from 196 to 441 kN/m), and especially preferably from 300 to 400 kg/cm (from 294 to 392 kN/m).

A magnetic recording medium obtained is cut to a desired size for use with a cutter. The cutter is not particularly restricted, but those having a plurality of pairs of rotating upper blade (a male blade) and lower blade (a female blade) are preferably used, so that a slitting rate, the depth of intermeshing, the peripheral ratio of upper blade (male blade) and lower blade (female blade) (peripheral speed of upper blade/peripheral speed of lower blade), and the continuous working time of slitting blades can be arbitrarily selected.

### Physical Characteristics:

The saturation magnetic flux density of the magnetic layer of a magnetic recording medium for use in the invention is preferably from 100 to 400 mT. The coercive force (Hc) of the magnetic layer is preferably from 143.2 to 318.3 kA/m (from 1,800 to 4,000 Oe), more preferably from 159.2 to 278.5 kA/m (from 2,000 to 3,500 Oe). The distribution of coercive force is preferably narrow, and SFD and SFDr is preferably 0.6 or less, and more preferably 0.3 or less.

A magnetic recording medium for use in the invention has a friction coefficient against a head of 0.50 or less in the range of temperature of −10 to 40° C. and humidity of from 0 to 95%, preferably 0.3 or less, surface specific resistance of a magnetic surface of preferably from 104 to 108 Ω/sq, and charge potential of preferably from −500 V to +500 V. The elastic modulus at 0.5% elongation of a magnetic layer is preferably from 0.98 to 19.6 GPa (from 100 to 2,000 kg/mm²) in every direction of in-plane, the breaking strength of a magnetic layer is preferably from 98 to 686 MPa (from 10 to 70 kg/mm²), the elastic modulus of a magnetic recording medium is preferably from 0.98 to 14.7 GPa (from 100 to 1,500 kg/mm²) in every direction of in-plane, the residual elongation is preferably 0.5% or less, and the thermal shrinkage factor at every temperature of 100° C. or less is preferably 1% or less, more preferably 0.5% or less, and most preferably 0.1% or less.

The residual amount of solvent contained in a magnetic layer is preferably 100 mg/m² or less, and more preferably 10 mg/m² or less. The void ratio of coated layers is preferably 30% by volume or less, and more preferably 20% by volume or less, with both of a nonmagnetic layer and a magnetic layer. The void ratio is preferably smaller for achieving high output, but there are cases where it is preferred to secure a specific value of void ratio depending upon purposes. For example, in a disc medium in which repeated use is of importance, large void ratio contributes to good running durability in many cases.

It is preferred that ten point average roughness Rz of a magnetic layer is 30 nm or less. These can be easily controlled by the control of the surface property of a support with fillers and by the surface configurations of the rolls of calendering treatment. Curling is preferably within ±3 mm.

In a magnetic recording medium in the invention, these physical characteristics can be varied according to purposes in a nonmagnetic layer and a magnetic layer. For example, the elastic modulus of a magnetic layer is made higher to improve running durability and at the same time the elastic modulus of a nonmagnetic layer is made lower than that of the magnetic layer to improve the head touching of the magnetic recording medium.

### Magnetic Recording or Reproducing Method:

As the reproducing method of a magnetic recording medium in the invention, it is preferred to use an MR head to reproduce signals magnetically recorded by the maximum linear recording density of 200 KFCI or more.

An MR head is a head that utilizes magneto-resistance effect responding to the size of magnetic flux of a magnetic head of thin film, and has the advantage that high reproduction output that cannot be obtained with an inductive type head can be obtained. This is mainly due to the fact that reproduction output of an MR head is not dependent upon the relative speed of the disc and head, since reproduction output of an MR head is based on the variation of magneto-resistance, and also high output can be obtained as compared with an inductive type magnetic head. By using such an MR head as the reproduction head, excellent reproducing characteristics can be ensured in high frequency region.

When a magnetic recording medium in the invention is in the form of a tape, reproduction with high C/N ratio is possible by the use of an MR head as the reproducing head even if the signals are those recorded in high frequency regions as compared with conventional ones. Accordingly, a magnetic recording medium in the invention is suitable as a magnetic tape and a disc-like magnetic recording medium for computer data recording for higher density recording.

### EXAMPLES

The invention will be described more specifically with reference to examples. The components, ratios, operations and orders described herein can be changed without departing from the spirit and scope of the invention, and the invention is not limited to the following examples. In the examples “parts” means “mass parts” unless otherwise indicated.

### Example 1

### Preparation of Magnetic Coating Solution for Upper Layer:

| | | |
|---|---|---|
| Ferromagnetic tabular hexagonal ferrite | 100 | parts |
| powder | | |
| Composition (molar ratio) exclusive of oxygen: | | |
| Ba/Fe/Co/Zn = 1/9/0.2/1 | | |
| Hc: 15.9 kA/m (200 Oe) | | |
| Average tabular size: 25 nm | | |
| Average tabular ratio: 3 | | |
| Specific surface area (S_{BET}): 80 m²/g | | |
| σₛ: 50 A·m²/kg (50 emu/g) | | |
| Polyurethane resin PUA-1 | 15 | parts |
| Phenylphosphonic acid | 3 | parts |
| Diamond powder (average particle size: 80 nm) | 3 | parts |
| Carbon black (average particle size: 20 nm) | 1 | part |
| Cyclohexanone | 110 | parts |
| Methyl ethyl ketone | 100 | parts |
| Toluene | 100 | parts |
| Butyl stearate | 2 | parts |
| Stearic acid | 1 | part |

### Preparation of Nonmagnetic Coating Solution for Lower Layer:

| | | |
|---|---|---|
| Nonmagnetic inorganic powder: α-Iron oxide | 85 | parts |
| Surface covering compounds: Al₂O₃ and SiO₂ | | |
| Average long axis length: 0.15 μm | | |
| Tap density: 0.8 | | |
| Average acicular ratio: 7 | | |
| Specific surface area (S_{BET}): 52 m²/g | | |
| pH: 8 | | |
| DBP oil absorption amount: 33 ml/100 g | | |
| Carbon black | 20 | parts |
| DBP oil absorption amount: 120 ml/100 g | | |
| pH: 8 | | |
| Specific surface area (S_{BET}): 250 m²/g | | |
| Volatile content: 1.5% | | |
| Polyvinyl chloride | 13 | parts |
| Polyurethane resin PUA-1 | 8 | parts |
| Phenylphosphonic acid | 3 | parts |
| α-Al2O3 (average particle size: 0.2 μm) | 5 | parts |
| Polyisocyanate curing agent | 5 | parts |
| Cyclohexanone | 140 | parts |
| Methyl ethyl ketone | 170 | parts |
| Butyl stearate | 2 | parts |
| Stearic acid | 1 | part |

### Coating Components for Back Coat Layer:

The same composition as the nonmagnetic coating solution for a lower layer

With each of the composition of magnetic coating solution for an upper layer and the composition of nonmagnetic coating solution for a lower layer, the components were kneaded in an open kneader for 60 minutes, and then dispersed in a sand mill for 120 minutes. Three parts of a trifunctional low molecular weight polyisocyanate compound (Coronate 3041, manufactured by Nippon Polyurethane Industry Co., Ltd.) was added to each obtained dispersion, each solution was further blended by stirring for 20 minutes, and then filtered through a filter having an average pore diameter of 1 μm, whereby a magnetic coating solution and a nonmagnetic coating solution were obtained. The nonmagnetic coating solution was coated on a polyethylene naphthalate support having a thickness of 5.2 μm (the central plane surface roughness Ra of the magnetic layer side: 0.8 nm, and the central plane surface roughness Ra of the back coat layer side: 1.3 nm) in a dry thickness of 1.5 μm and dried at 100° C. Immediately after that, the magnetic coating solution was coated on the nonmagnetic layer in a dry thickness of 0.08 μm by wet-on-dry coating and dried at 100° C. In the next place, the back coat layer coating solution was coated on the side of the nonmagnetic support opposite to the side on which the nonmagnetic lower layer and the magnetic layer were formed in a dry thickness after calendering treatment of 0.5 μm, and dried. The web was subjected to surface smoothing treatment with calender of seven stages comprising metal rolls alone at a velocity of 100 m/min, linear pressure of 300 kg/cm (294 kN/m), and temperature of 90° C., further subjected to thermosetting treatment at 70° C. for 24 hours, and then slit to ½ inch wide to obtain a magnetic tape.

### Example 2

Example 1 was repeated, except that the amount of polyisocyanate curing agent in the coating components for the back coat layer was decreased to 2 parts and the ratio of Young's modulus (R) was made larger.

### Example 3

Example 1 was repeated, except that 3 parts of nitrocellulose resin was added to the coating components for the back coat layer and the ratio of Young's modulus (R) was made smaller.

### Comparative Example 1

Example 1 was repeated, except that the coating components for back coat layer were changed as shown below, the ratio of Young's modulus (R) was made smaller, and the central plane surface roughness Ra of the back coat layer was made larger.

### Coating Components for Back Coat Layer in Comparative Example 1:

| | | |
|---|---|---|
| Carbon black (average particle size: 25 nm) | 40.5 | parts |
| Carbon black (average particle size: 370 nm) | 0.5 | parts |
| Barium sulfate | 4.05 | parts |
| Nitrocellulose | 28 | parts |
| Polyurethane resin (containing a SO₃Na group) | 20 | parts |
| Cyclohexanone | 100 | parts |
| Toluene | 100 | parts |
| Methyl ethyl ketone | 100 | parts |
| Polyisocyanate curing agent | 8.5 | parts |

### Comparative Example 2

Example 1 was repeated, except that a polyethylene naphthalate support having the central plane surface roughness Ra of the magnetic layer side of 0.8 nm, and the central plane surface roughness Ra of the back coat layer side of 3.0 nm was used as the support.

### Comparative Example 3

Example 1 was repeated, except that polyvinyl chloride and polyisocyanate curing agent were not added to the coating components for back coat layer, and the addition amount of polyurethane resin PUA-1 was changed to 20 parts.

### Comparative Example 4

Example 1 was repeated, except that the lower nonmagnetic layer was not provided.

Glass transition point Tg of each layer, the central plane surface roughness Ra, the ratio of Young's modulus (R), Ra of the support on the back coat layer side, and S/N ratio were examined as shown in Table 1 below on the magnetic tapes manufactured in Examples and Comparative Examples. The methods of evaluation are as follows.
Glass transition point Tg: The temperature dependency of dynamic viscoelasticity was measured by frequency of 110 Hz at a rate of temperature increase of 3° C./min, and the peak of the obtained temperature dependency curve of the loss elastic modulus E″ is taken as glass transition point Tg.
Central plane surface roughness Ra: Central plane surface roughness Ra was measured with a digital optical profiler HD2000 (manufactured by WYKO) on the condition of cut-off value of 160 nm and the area of 242.4 μm×184.2 μm.
Young's modulus: Young's modulus was measured with a tensile tester. The Young's modulus measured is a value in the machine direction. The Young's modulus of the whole of the magnetic tape was measured first, and then the Young's modulus of the magnetic tape after peeling the back coat layer alone was measured, and the Young's modulus of the back coat layer was found from the difference of these Young's moduli.
S/N Ratio: S/N Ratio was measured with LTO Gen 2 drive mounting a head having the depth of a pit part of MR element of 15 nm by relative velocity of 4 m/sec, linear density of 160 kfci (bit length: 0.166 μm), and reproducing track width of 12.7 μm.

The results obtained are shown in Table 1.

TABLE 1

| | | Tg of Coated | | Ra of | | | | |
|---|---|---|---|---|---|---|---|---|
| | | Layers | | Support | | | | |
| | | (magnetic | Tg of | of Back | Ratio | Ra of | | |
| | | layer and | Back | Coat | of | Back | Ra of | |
| | Lower | nonmagnetic | Coat | Layer | Young's | Coat | Magnetic | S/N |
| Example | Nonmagnetic | layer) | Layer | Side | Modulus | Layer | Layer | Ratio |
| No. | Layer | (° C.) | (° C.) | (nm) | (R) | (nm) | (nm) | (dB) |
| Example 1 | Present | 87 | 87 | 1.3 | 1.01 | 3.2 | 1.6 | 1.9 |
| Example 2 | Present | 87 | 80 | 1.3 | 1.17 | 3.2 | 2.0 | 0.6 |
| Example 3 | Present | 93 | 87 | 1.3 | 0.83 | 3.4 | 2.2 | 0.0 |
| Comparative | Present | 87 | 132 | 1.3 | 0.43 | 5.1 | 3.9 | −2.6 |
| Example 1 | | | | | | | | |
| Comparative | Present | 87 | 87 | 3.0 | 1.03 | 4.7 | 3.1 | −1.4 |
| Example 2 | | | | | | | | |
| Comparative | Present | 87 | 70 | 1.3 | 1.37 | 3.3 | 3.3 | −1.6 |
| Example 3 | | | | | | | | |
| Comparative | Absent | 70 | 87 | 1.3 | 0.60 | 3.3 | 3.0 | −1.3 |
| Example 4 | | | | | | | | |

From the results in Table 1, the following things are confirmed.

The magnetic recording media in Examples 1 to 3 could achieve magnetic layer smoothness suitable for high recording density and high electromagnetic characteristics could be obtained.

The magnetic recording medium in Comparative Example 1 was high in the glass transition point Tg of the back coat layer and low in the ratio of the Young's modulus (R), so that the central plane surface roughness Ra of the magnetic layer became large and high S/N ratio could not be obtained.

The magnetic recording medium in Comparative Example 2 was high in Ra of the back coat layer, so that Ra of the magnetic layer became large by the influence of back imprinting and high S/N ratio could not be obtained.

The magnetic recording medium in Comparative Example 3 was low in Tg of the back coat layer and high in the ratio of the Young's modulus (R), so that Ra of the magnetic layer became large and high S/N ratio could not be obtained.

The magnetic recording medium in Comparative Example 4 did not have a lower nonmagnetic layer and low in the ratio of the Young's modulus (R), so that Ra of the magnetic layer became large and high S/N ratio could not be obtained.

This application is based on Japanese Patent application JP 2006-99941, filed Mar. 31, 2006, the entire content of which is hereby incorporated by reference, the same as if set forth at length.

What is claimed is:

1. A magnetic recording medium comprising:
a back coat layer;
a nonmagnetic support; and
coated layers including: a nonmagnetic layer containing nonmagnetic powder and a binder; and a magnetic layer containing ferromagnetic powder and a binder, so that the back coat layer, the nonmagnetic support, the nonmagnetic layer and the magnetic layer are provided in this order,
wherein the ferromagnetic powder is ferromagnetic hexagonal ferrite powder having an average tabular size of less than 30 nm, the magnetic layer has a central plane surface roughness Ra of from 1.0 to 2.5 nm, the back coat layer has a central plane surface roughness Ra of from 2.0 to 4.0 nm, the coated layers has a glass transition point of from 75 to 100° C., the back coat layer has a glass transition point of from 75 to 100° C., and a ratio of a Young's modulus of the magnetic layer to a Young's modulus of the back coat layer is from 0.8 to 1.20.

2. The magnetic recording medium as claimed in claim 1, wherein the ferromagnetic hexagonal ferrite powder has an average tabular size of from 10 to 29 nm.

3. The magnetic recording medium as claimed in claim 1, wherein the ferromagnetic hexagonal ferrite powder has an average tabular size of from 15 to 25 nm.

4. The magnetic recording medium as claimed in claim 1, wherein the magnetic layer has a central plane surface roughness Ra of from 1.2 to 2.3 nm.

5. The magnetic recording medium as claimed in claim 1, wherein the magnetic layer has a central plane surface roughness Ra of from 1.4 to 2.2 nm.

6. The magnetic recording medium as claimed in claim 1, wherein the back coat layer has a central plane surface roughness Ra of from 2.5 to 4.0 nm.

7. The magnetic recording medium as claimed in claim 1, wherein the back coat layer has a central plane surface roughness Ra of from 3.0 to 3.6 nm.

8. The magnetic recording medium as claimed in claim 1, wherein the coated layers has a glass transition point of from 80 to 95° C.

9. The magnetic recording medium as claimed in claim 1, wherein the coated layers has a glass transition point of from 85 to 95° C.

10. The magnetic recording medium as claimed in claim 1, wherein the back coat layer has a glass transition point of from 80 to 95° C.

11. The magnetic recording medium as claimed in claim 1, wherein the back coat layer has a glass transition point of from 85 to 95° C.

12. The magnetic recording medium as claimed in claim 1, wherein the ratio of a Young's modulus of the magnetic layer to a Young's modulus of the back coat layer is from 0.85 to 1.15.

13. The magnetic recording medium as claimed in claim 1, wherein the ratio of a Young's modulus of the magnetic layer to a Young's modulus of the back coat layer is from 0.90 to 1.10.

14. The magnetic recording medium as claimed in claim 1, wherein the back coat layer contains carbon black and inorganic powder.

15. The magnetic recording medium as claimed in claim 1, wherein the back coat layer has a thickness of 0.9 μm or less.

16. The magnetic recording medium as claimed in claim 1, wherein the back coat layer has a thickness of from 0.1 to 0.7 μm.

17. The magnetic recording medium as claimed in claim 1, wherein the nonmagnetic support contains polyester.

18. The magnetic recording medium as claimed in claim 1, wherein the nonmagnetic support has a thickness of from 3 to 80 μm.
